(19) United States
(12) Patent Application Publication
(10) Pub. No.: US 2005/0081413 A1
(43) Pub. Date: Apr. 21, 2005

(54) Reelable sign device

(76) Inventor: Wen-Shn Ko, Taipei City (TW)

Correspondence Address: Wen-Shn KO, PO Box No. 6-57, Junghe, Taipei, 235, TW

(21) Appl. No.: 10/745,492

(22) Filed: Dec. 29, 2003

(30) Foreign Application Priority Data
Oct. 15, 2003 (TW) 092218309

(51) Int. Cl. G09F 11/18; G09F 21/04

(52) U.S. Cl. 40/514; 40/591

(57) ABSTRACT

A reelable sign device for warnings, information and directions include a reel structure having a reel and a long opening, a soft curtain with sign marks for signaling, and a brace with a plurality of fixtures to uphold the outstretched soft curtain with sign marks. The soft curtain with sign marks is connected to the reel structure and capable of being furled and folded up into the reel structure through the long opening. The sign marks on the signaling side of the soft curtain are a combination of drawings, symbols and characters composed of photo-reflective and photo-luminescent materials. With the reel structure and the soft curtain with sign marks, the reelable sign device can be stored easily and setup promptly. The large reflection and luminance area of the outstretched soft curtain with distinguishably visible sign marks enables the reelable sign device apparent from a long distance.

### BACKGROUND OF THE INVENTION

1) Field of the Invention

The present invention provides a reelable sign device mainly having a reel structure and a soft curtain which enable the reelable sign device to be promptly furled and folded up for easy storage. With large areas of photo-reflective and photo-luminescent sign marks on the soft curtain for warnings, information and directions, the reelable sign device is distinguishably visible from a long distance.

2) Description of the Prior Art

Along with modern technology, vehicles are becoming necessities of our daily life. When a vehicle is broken down on a road, it is a must for the driver to set up warning signs around the vehicle as quickly as possible to avoid accidents. Most of the currently used warning sign devices are constructed of triangular frames with photo-reflective surfaces, providing signaling reflection shine caused by the headlights of passing vehicles. Normally the currently used warning sign devices are too small to be visible enough from a long distance since the size of the triangular constructions is against easy storage and portability. As a result, we often see a driver standing behind a broken down vehicle and waving his hands with flashlights for extra warnings. In order to provide more safety signals to other drivers in a long distance, warning sign devices having large areas of luminance as well as reflection, which can be easily stored and set up, are in great demand.

Referring to FIG. 1, a triangular warning sign device mainly composed of a warning light set and a power supply is shown. The warning light set has two lines of triangular light tubes (1) filled with neon gas and fluorescent powder. The power supply (2) with two sets of wires is disposed on the bottom of the triangular light tubes (1). The two sets of wires are correspondingly connected to the triangular light tubes (11) (12) to make the warning sign device signaling properly. However, the warning sign device needs a power source. Under urgent circumstances, users do not have time to check the battery power. Once the battery is not prepared, the warning sign device will not work well. Moreover, it is not easy to fold and unfold the triangular warning sign device promptly. To carry and store the triangular warning sign device is, therefore, not very convenient.

As a result, a warning sign device with a quick and easy way of folding up is helpful.

### SUMMARY OF THE INVENTION

One primary object of the present invention is to provide a sign device with a reel structure and a soft curtain that the sign device can be easily stored and quickly set up. To achieve the object, the reelable sign device is comprised of a reel structure having a reel and a long opening, a large soft curtain with sign marks connected to the reel and capable of being scrolled and folded up into the reel structure through the long opening, and braces fixed in the reel structure for supporting the extended soft curtain with sign marks.

The other object of the present invention is to provide the reelable sign device with a large area of not only reflection but also luminance for more safety signals along a distance. To achieve the object, the display surface of the soft curtain is covered with films of photo-reflective and photo-luminescent materials to compose (print, paint or paste) drawings, symbols and characters as warning sign marks. The color difference and brightness contrast between the photo-reflective and the photo-luminescent sign marks on the large soft curtain makes the reelable sign device distinguishably visible along a distance.

There are different applications of the invented reelable sign device to provide information, warnings and directions. However, the device features on the reel structure and the large soft curtain as well as the high signaling effects of the sign marks, owing to the films of different photo-reflective and photo-luminescent materials.

### BRIEF DESCRIPTION OF THE DRAWINGS

The accomplishment of the above-mentioned objects of the present invention will become apparent from the following description and its accompanying drawings which disclose illustrative an embodiment of the present invention, and are as follows:

FIG. 1 shows a triangular warning sign device of a prior art;

FIG. 2(a)(b)(c) shows an embodiment of the invented reelable sign device;

FIG. 3 shows another embodiment of the invented reelable sign device;

FIG. 4 shows a further embodiment of the invented reelable sign device.

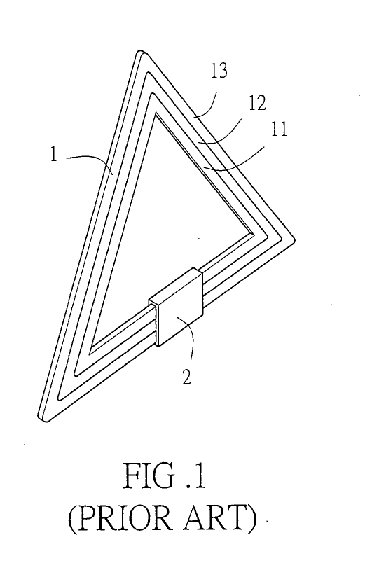

### DETAILED DESCRIPTION OF THE PREFERRED EMBODIMENT

The present reelable sign device has various applications such as road signs, information signs, direction signs, and advertising billboards.

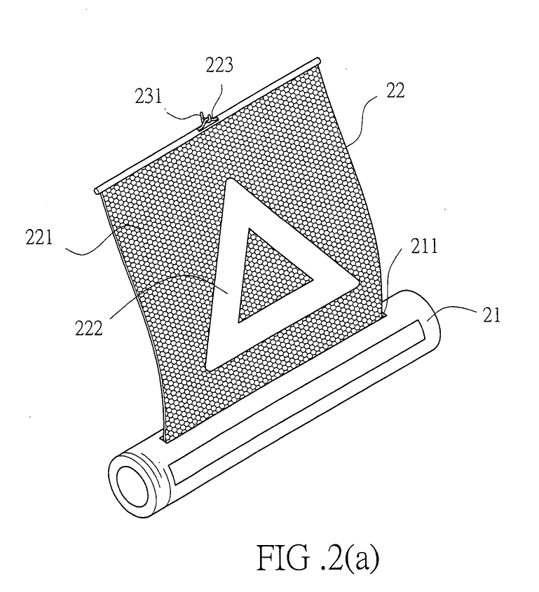

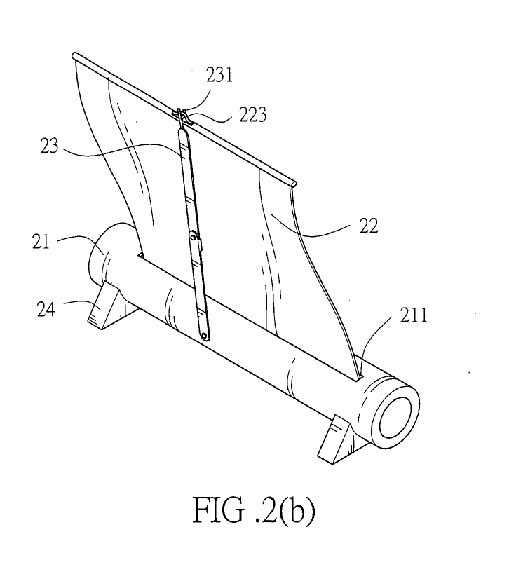

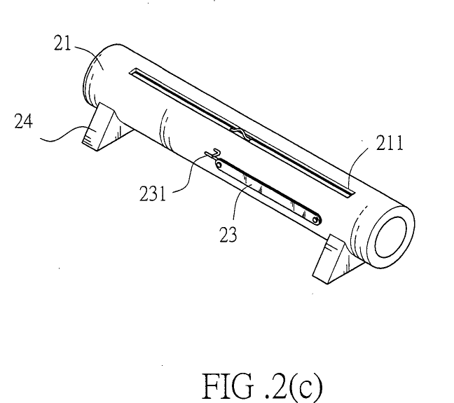

Referring to FIG. 2(a)(b)(c), an embodiment of the present invention is illustrated. The reelable sign device has a reel structure (21) with a long opening (211). A soft curtain (22) with sign marks (222), connected to the reel structure (21), is capable of being furled and folded up into the reel structure (21) through the long opening (211) as shown in FIG. 2(c). A brace (23) is equipped to extend and support the unfurled and unfolded soft curtain (22) for displaying the sign marks (222). The soft curtain (22) is covered with a film of photo-reflective materials as the base substrate (221). The sign marks (222) are composed of, by printing, painting and pasting, photo-luminescent films and photo-reflective materials of different color and brightness grades to the base substrate (221).

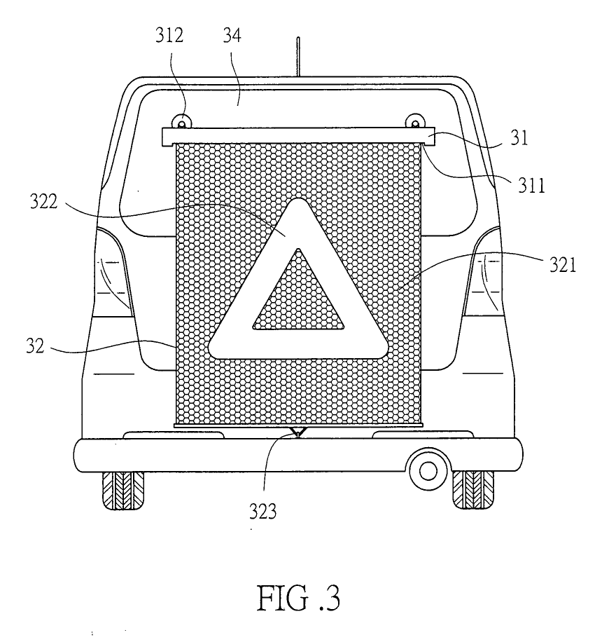

In accordance with the reelable sign device described above, an embodiment of the present invention as shown in FIG. 2(a) is a soft curtain (22) marked with a red triangular warning sign. The triangular mark (222) can be changed to other drawings, symbols and characters according to different applications and various user requirements. In addition, the soft curtain with sign marks (22) can be made to different shapes and sizes. Referring to FIG. 2(a)(b), a brace (23) is fixed in the reel structure (21) with a pivot on one end. A hook (231) on the other end of the brace hangs a crook (223) mounted on the top of the soft curtain with sign marks (22). Moreover, a foldable mounting frame (24), such as a tripod stand, is equipped to the reel structure (21), which enables the reelable sign device to stand and rest firmly on the ground. Referring to FIG. 3, an embodiment of a vehicle breakdown warning sign device in accordance with the present invention is illustrated. The vehicle break down warning sign device has a reel structure (31) with a long opening (311). A warning sign curtain (32) is connected to the reel structure (31), capable of being furled and folded up into the reel structure through the long opening (311). The warning sign curtain (32) has a triangular mark (322) on the base substrate (321), made of different color and brightness grades of photo-reflective and photo-luminescent materials. The vehicle break down warning sign device is installed on the rear (34) of a hatchback vehicle by means of a plurality of suction cups (312), hooks and crooks (323).

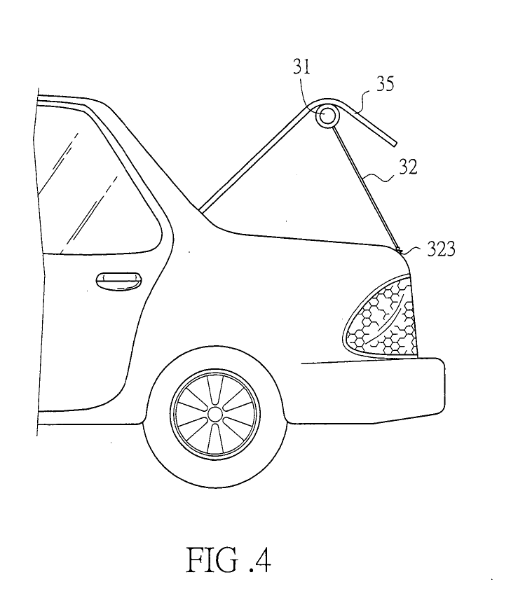

There are various types of vehicles such as station wagon, sedan, coupe, hatchback, pickup, MPV and SUV. A reelable sign device of the present invention applies different fixtures and adhesive means to different types of vehicles. FIG. 4 shows a further embodiment of the present invention that a reelable warning sign device is applied to a sedan. The reel structure (31) is fixed on an inner panel of the trunk lid. As the sign curtain (32) is pulled out of the reel structure, a hook (323) on the bottom of the sign curtain is attached to a crook on a lower body panel of the trunk to secure the sign curtain unfolded.

Since the sign curtain is soft, it is, as a result, easy and convenient to furl, fold up, stretch out and set up a reelable sign device of the present invention. In addition, the soft curtain with sign marks is covered with different color and brightness grades of photo-reflective and photo-luminescent materials. Due to the highly contrasted reflection and luminescence between the base substrate and the sign marks, the present reelable sign device is visible from a long distance when the sign curtain is fully outstretched.

In a summary, the present invention provides a reelable sign device for warnings, information and directions. The sign device has a soft curtain and a reel structure that the soft curtain can be quickly furled and folded up into the reel structure for convenient storage and easy setup. The soft curtain is covered with, by printing, painting and pasting, films of photo-reflective and photo-luminescent materials to compose drawings, symbols and characters as sign marks. Since different color and brightness grades of the materials are used, the sign marks on the soft curtain can be distinguishably visible. Both of the photo-reflective and the photo-luminescent materials applied are market available, a reelable sign device of the present invention with low costs and great commercial values can be achieved.

It should be noted that the above description and accompanying drawings are only used to illustrate some embodiments of the present invention, not intended to limit the scope thereof. Any modification of the embodiments should fall within the scope of the present invention.

1. A reelable sign device comprising:
a reel structure having a reel, a long opening and a mounting stand;
a soft curtain with sign marks connected to said reel structure; and
at least one brace to uphold said fully extended and outstretched soft curtain for displaying said sign marks.

2. The reelable sign device as claimed in claim 1, wherein said soft curtain with sign marks is supple and capable of being furled and folded up into said reel structure through said long opening.

3. The reelable sign device as claimed in claim 1, wherein said sign marks are drawings, symbols or characters for warnings, information and directions.

4. The reelable sign device as claimed in claim 1, wherein said soft curtain is covered with films of different grades of photo-reflective and photo-luminescent materials, by printing, painting and pasting, to compose said sign marks.

5. The reelable sign device as claimed in claim 1, wherein one end of said soft curtain with sign marks is fixed in said reel structure and the other end is hanged on said brace while said soft curtain with sign marks is outstretched.

6. The reelable sign device as claimed in claim 1, wherein a plurality of fixtures are equipped to hang said outstretched soft curtain with sign marks on said brace.

7. The reelable sign device as claimed in claim 1, wherein said mounting stand of said reel structure is a set of foldable tripod frame and suction cups which can be easily dismantled.

8. A vehicle breakdown warning sign device comprising:
a reel structure with a reel and a long opening; and a soft curtain with warning signs connected to said reel structure and capable of being furled and folded up into said reel structure through said long opening.

9. The vehicle breakdown warning sign device as claimed in claim 8, wherein said reel structure is installed to the rear of vehicles with a plurality of mounting fixtures.

10. The vehicle breakdown warning sign device as claimed in claim 8, wherein a plurality of mounting fixtures are used to support and extend said soft curtain for displaying said warning signs.

11. The vehicle breakdown warning sign device as claimed in claim 8, wherein said warning signs on said soft curtain are drawings, symbols or characters.

12. The vehicle breakdown warning sign device as claimed in claim 8, wherein said warning signs having various color and brightness grades of photo-reflective and photo-luminescent materials are attached on said soft curtain by printing, painting or pasting.
